(19) United States
(12) Patent Application Publication
(10) Pub. No.: US 2012/0167920 A1
(43) Pub. Date: Jul. 5, 2012

(54) METHOD FOR CARRYING OUT A DISHWASHING PROGRAM

(75) Inventors: Andre Bertram, Bielefeld (DE); Tobias Dahms, Hannover (DE)

(73) Assignee: MIELE & CIE. KG, Guetersloh (DE)

(21) Appl. No.: 13/339,491

(22) Filed: Dec. 29, 2011

(30) Foreign Application Priority Data
Jan. 5, 2011 (DE) 10 2011 000 042.9

(51) Int. Cl. B08B 3/10; B08B 7/00

(52) U.S. Cl. 134/18; 134/19

(57) ABSTRACT

A method for carrying out a dishwashing program in an automatic dishwasher includes a washing step, an intermediate cleaning and a clear rinsing. The washing step includes heating water present in a tub of the dishwasher using at least a condenser of a heat pump. The clear rinsing includes heating water present in the dishwasher tub using the condenser together with an electric heater.

### CROSS REFERENCE TO RELATED APPLICATIONS

This application claims priority from German Patent Application No. DE 10 2011 000 042.9, filed Jan. 5, 2011, which is hereby incorporated by reference herein in its entirety.

### FIELD

The invention relates to a method for carrying out a dishwashing program in an automatic dishwasher that comprises at least the following program steps: washing, intermediate cleaning and clear rinsing, whereby at least the washing and clear rinsing steps of the program entail heating water that is present in a dishwasher tub, for which purpose an electric heater as well as the condenser of a heat pump are used.

### BACKGROUND

Automatic dishwashers, or dishwashing machines, serve to clean dishes and utensils. In the normal application case, the dishwasher executes a dishwashing program, at the end of which the dishes are clean and, as a rule, also dry. Within the scope of the execution of the dishwashing program, several individual program steps are carried out, and at least a few of them involve the use of heated dishwashing water. Since the water fed into the dishwasher is usually cold, it has to be heated up in such cases, and for this purpose, the automatic dishwashers known from the state of the art are equipped with an electric heater.

Also during proper operation of a dishwasher, most of the energy consumed is due to the heating of the dishwashing water, that is to say, due to the use of the electric heater to heat up the dishwashing water. The energy consumption of an automatic dishwasher can be reduced by lowering the maximum temperatures that can be reached in the individual dishwashing phases, by reducing the amount of dishwashing water fed into the dishwasher, and/or by improving the heat insulation. However, there are limits to these measures and the automatic dishwashers known from the state of the art have fundamentally already made full use of these measures.

Electric heaters of most automatic dishwashers generate a heating output of about 2 to 3 kW. If one wanted to replace the electric heater completely by a heat pump, then this heat pump would likewise have to generate a heating output of about 2 kW to 3 kW. However, the physical dimensions of a heat pump that generates such an output are much too large for the installation space available in an automatic dishwasher. The complete replacement of an electric heater by a heat pump is thus not an option, at least not without considerably enlarging the dimensions of the dishwasher.

The installation space available in a typical automatic dishwasher is generally sufficient for a heat pump that generates an output of about 500 watts to 600 watts. When only such a heat pump is used, energy savings of over 60% for heating up the dishwashing water can be achieved in comparison to operation involving an electric heater. However, a drawback is that the low heating output of such a heat pump in comparison to an electric heater means that the dishwashing programs take considerably longer. Fast as well as intensive dishwashing programs are not possible when only a heat pump is used.

Heat pumps of this type typically have an evaporator, a compressor as well as a condenser. In order to cut costs and save installation space when a heat pump is to be used in conjunction with an automatic dishwasher, the invention proposes using a compressor on the heat pump side that has a relatively low output of, for example, about 200 watts. Therefore, at a typical heat pump factor of 3, the heat pump generates a heating output of about 600 watts at the condenser.

When only such a heat pump is used to heat the dishwashing water, about two-thirds of the energy needed can be saved in comparison to the use of an electric heater. A drawback, however, is that, since the heating output is four times lower than with an electric heater, the heating times are correspondingly four times longer. As a consequence, conventional dishwashing programs can no longer be used.

It is also problematic that, in order to enable heating to temperatures of up to 75° C., which are needed, for instance, for intensive dishwashing programs, the technical complexity of the heat pump is greater, especially since the efficiency of the heat pump drops as the temperature differential rises.

Nevertheless, there is still the goal of lowering the energy consumption of an automatic dishwasher.

### SUMMARY

In an embodiment, the present invention provides a method for carrying out a dishwashing program in an automatic dishwasher that includes a washing step, an intermediate cleaning and a clear rinsing. The washing step includes heating water present in a tub of the dishwasher using at least a condenser of a heat pump. The clear rinsing includes heating water present in the dishwasher tub using the condenser together with an electric heater.

### BRIEF DESCRIPTION OF THE DRAWINGS

Exemplary embodiments of the present invention are described in more detail below with reference to the drawings, in which:

FIG. 1 is a schematic depiction of the principle of a compression heat pump;

FIG. 2 is a schematic depiction of an automatic dishwasher according to an embodiment of the invention equipped with a heat pump, and

FIG. 3 is a diagram of the temperature curve of a dishwashing program according to the state of the art (broken line) and according to the invention (solid line).

### DETAILED DESCRIPTION

In an embodiment, the present invention provides a method for carrying out a dishwashing program that has a lower energy consumption than conventional dishwashing programs, but that does not entail a worse cleaning result.

In order to achieve this, embodiments of the invention use an electric heater as well as the condenser of a heat pump to heat up the water, and to at least primarily use the condenser during the washing step of the program, and to use the condenser together with the electric heater during the clear rinsing step of the program.

Thus, a heat pump is used to heat up water that is present in the dishwasher tub. However, this heating of the dishwashing water is not done only by the condenser of the heat pump, but rather, an electric heater is additionally switched on; this is done according to embodiments of the invention when the condenser alone cannot generate the requisite heat output, or when the dishwashing water has to be heated up to temperatures at which the heat pump would function inefficiently, or when heating up the water using only the heat pump would take too long. Therefore, the heat pump that is used operates alone when the heat output generated by the heat pump is sufficient to reach the washing temperature prescribed by the program in a given washing phase. This is the case, for example, in an energy-saving program in which the water that is present in the dishwasher tub is heated up to above 45° C., preferably to 50° C., during the washing step of the program. If this washing temperature cannot be reached by the heat pump alone, at least not during the heating phase provided for this by the dishwashing program, then the electric heater is added to assist the heat pump. This is advantageous, for example, in the clear rinsing step of the program, during which temperatures between 60° C. and 70° C. are commonly used, but also in the washing step of the program during an “intensive washing” program of the dishwashing water at high temperatures (>60° C.). In this manner, it is advantageously achieved that the energy consumption for heating up the dishwashing water is reduced while staying within the prescribed dishwashing times.

Normally, intermediate cleaning takes place between the washing step of the program and the clear rinsing step of the program. The intermediate cleaning serves to replace the water and, if necessary, to remove washing residues and/or detergent residues. In some heating methods, the electric heater is switched off during such an intermediate cleaning procedure. With the method execution according to embodiments of the invention, the heat pump can remain in operation during this intermediate phase as well. This has the effect of immediately heating up the new dishwashing water that enters the dishwasher in order to replace the previous water. As a result, this measure contributes to the fact that the electric heater can be switched on as late as possible during the second heating phase and thus contributes to saving energy.

It is also preferred that, in order to further reduce the energy consumption, initially only the condenser is operated as the heater during a first heating phase at the beginning of the clear rinsing step of the program, and the electric heater is switched on additionally only during the further course of the process. In a program step that uses high dishwashing water temperatures, such a measure can also be advantageous during the washing step of the program. Here, it is also advantageous for the second heating phase to be followed by a third heating phase in which exclusively the electric heater is operated until the desired final temperature is reached. This prevents an inefficient operation of the heat pump. The phases can be switched in a time-controlled manner. This is always useful when a prescribed program duration has to be adhered to. In addition or as an alternative, the control can be performed as a function of the dishwashing water temperature. This also means that the heat pump is only operated in the efficient working range.

According to another feature of an embodiment of the invention, the dishwasher has a control unit to carry out the method. This control unit has a measuring device and a comparator circuit, whereby the measuring device detects the actual temperature of the dishwashing water, and the comparator circuit compares the measured actual temperature to a predefinable target temperature and, if the actual temperature is too low, the electric heater is additionally switched on. In this manner, the method execution according to the invention can also be used for intensive and/or fast dishwashing programs. Although the percentage of the heat supplied only by the heat pump in such dishwashing programs might be less, in comparison to normal standard dishwashing programs, even such dishwashing programs require less energy, thanks to the use of the heat pump.

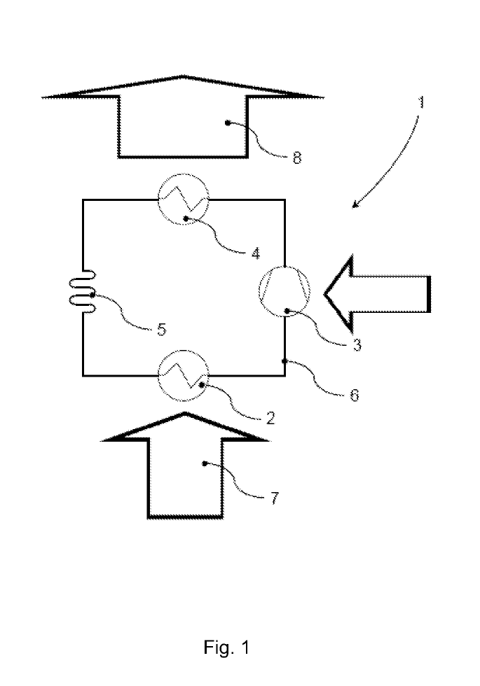

FIG. 1 shows a schematic depiction of the principle of a compression heat pump 1. The compression heat pump 1, referred to in short as the heat pump 1, has an evaporator 2, a compressor 3, a condenser 4 and a throttle point 5, which is depicted here as a capillary tube. The evaporator 2, the compressor 3, the condenser 4 and the throttle point 5 are components of a closed-flow circulation system 6 through which a coolant flows, namely, starting from the evaporator 2, going to the compressor 3, to the condenser 4, to the throttle point 5 and finally back to the evaporator 2.

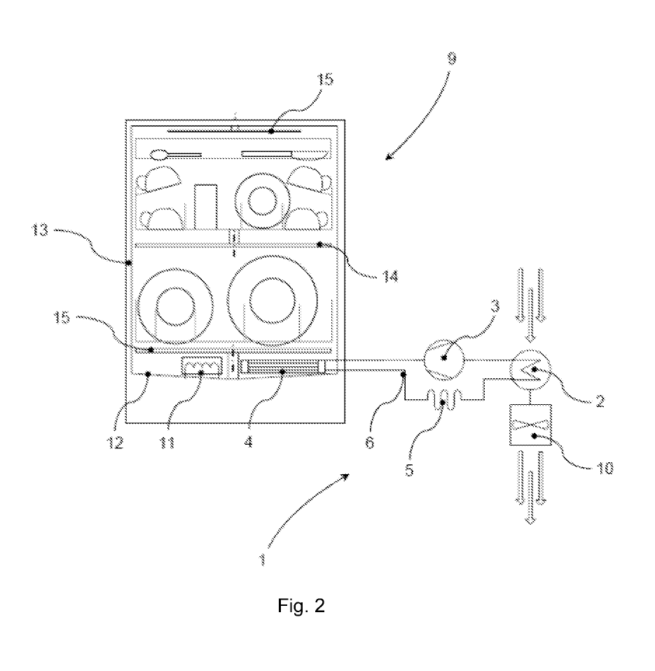

According to an embodiment of the invention, a heat pump 1 structured according to the above-mentioned principle is installed in a dishwasher 9 shown in FIG. 2. In this case, the room in which the dishwasher 9 is installed, that is to say, for example, the kitchen, serves as the heat source, which is shown as an arrow 7 in the depiction of FIG. 1. The heat is extracted from the room, for example, by means of an air heat exchanger. A fan 10 can be used to supply sufficient volumes of air to the air heat exchanger.

To an especially great extent, a reciprocating compressor or a rotary compressor that have an electric drive motor are suitable as the compressor 3. Such compressors are especially suitable because they can be connected via the electric mains connection that is already used for an automatic dishwasher 9 anyway.

On the condenser 4, which is configured as a water heat exchanger, the sum of ambient heat and drive energy is transferred to the dishwashing water of the dishwasher 9. This heat transfer is indicated by the arrow 8 in the schematic depiction of FIG. 1.

FIG. 2 shows an automatic dishwasher 9 that has a heat pump 1 as shown with its schematic mode of operation in FIG. 1. According to the embodiment of FIG. 2, the condenser 4 is configured as a tubular heat exchanger. It is arranged inside the dishwasher tub 13 of the dishwasher 9, namely, directly above the baseplate 12. During proper operation, the condenser 4 is thus surrounded by the dishwashing water that is inside the dishwasher 9.

In addition to the heat exchanger 4, the dishwasher 9 also has an electrically operated heater 11. This is likewise installed near the bottom of the dishwasher 9, that is to say, directly above the baseplate 12 of the dishwasher 9.

However, the condenser 4 and/or the electric heater 11 can also be arranged elsewhere in the dishwasher tub 13. Thus, for instance, it is conceivable to integrate the condenser 4 and/or the electric heater 11 into the dishwashing water circulation system of the circulation pump of the dishwasher 9, for example, between the circulation pump and one of the spray arms 14 or 15. Moreover, the possibility exists to configure a side wall, the lid or else the floor of the dishwashing tub 13 of the dishwasher 9 as a heat exchanger.

As already described on the basis of FIG. 1, a fan 10 can serve to ensure that a sufficient volume of air is fed to the air heat exchanger. Such a fan 10 is shown by way of example in FIG. 2.

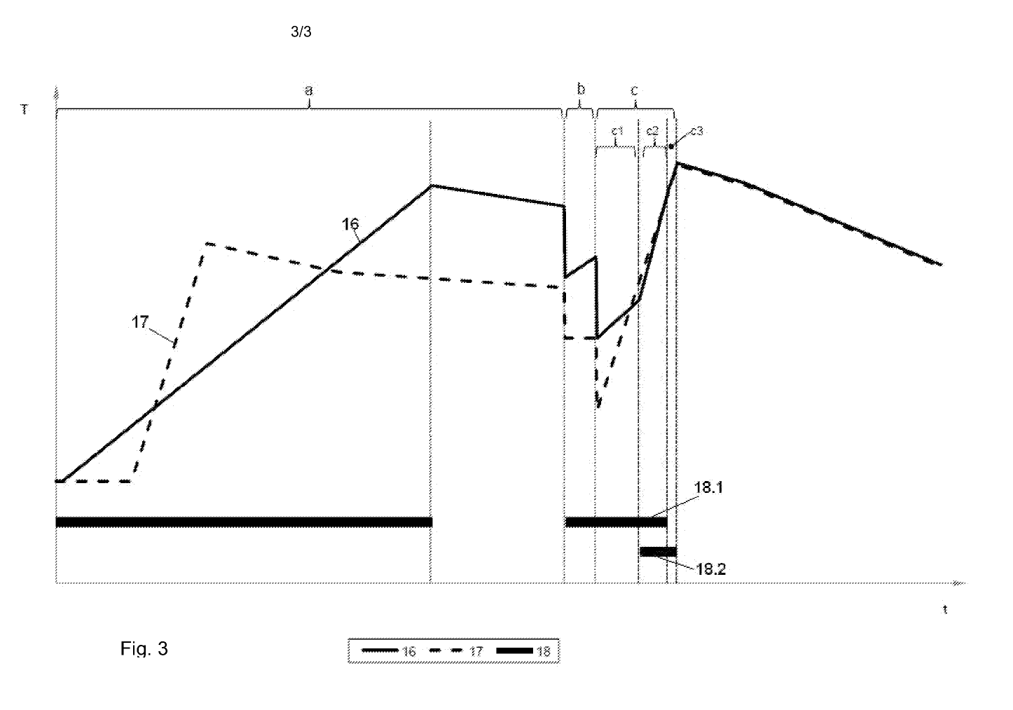

FIG. 3 illustrates a method according to an embodiment of the invention on the basis of a diagram of the program sequence. In the diagram, the washing temperature T is plotted over the program running time t. The solid curve, which is designated with 16, depicts a program sequence according to the invention, whereas the broken curve designated with 17 is a program sequence according to the state of the art, where thus exclusively an electric heater is used to heat up the dishwashing water. In addition, the diagram shows the switch-on times 18.1 of the heat pump 1 and 18.2 of the electric heater 11 for the method sequence according to the invention (solid curve 16).

The program sequence shown in FIG. 3 comprises three program steps, namely, the washing (a), the intermediate cleaning (b) and the clear rinsing (c). The program sequence 16 according to an embodiment of the invention and the program sequence 17 according to the state of the art consist of the following:

According to the state of the art shown by curve 17, in the washing step (a) of the program, first of all, dishwashing water is fed into the dishwasher tub 13. After a short pre-rinsing time, the electric heater 11 is switched on and, within a relatively short time, the heating of the dishwashing water to 45° C. is started. This temperature is reached after about 20 minutes. Then the heater is switched off, and the temperature drops to 40° C. for the subsequent holding time as shown in FIG. 3.

The method execution according to an embodiment of the invention as shown by curve 16 likewise starts in washing step (a) of the program with water being fed into the dishwasher tub 13. However, in contrast to the state of the art, the heat pump 1 is started right away when the water is being fed in. Due to the lower heating output of the condenser 4, the maximum temperature is only reached after about one hour, as a result of which the holding time is greatly shortened. In order for this shortening not to have a negative effect on the cleaning power during washing step (a) of the program, a higher maximum temperature of about 50° C. is selected.

During the intermediate cleaning step (b) of the program, first of all, the dishwashing water is replaced. This causes the temperature to drop. In the method (curve 17) according to the state of the art, the electric heater 11 is not operated. This differs from the method execution according to an embodiment of the invention. With the method execution according to an embodiment of the invention, the heat pump 1 is also switched on during the intermediate cleaning This is sensible because, as a result, most of the heat energy remains stored in the device as well as in the dishes and the cutlery, so that this heat energy is still available at the beginning of the clear rinsing step (c) of the program.

The water is once again replaced for the clear rinsing (c). Due to the higher temperature during the washing (a) and due to the heating during the intermediate cleaning (b), the starting temperature in the program execution according to an embodiment of the invention at the beginning of the clear rinsing step (c) of the program is about 10° C. higher than in a conventional program sequence as shown by curve 17. The reason for this is that the heat stored by the dishwasher tub 13 and by the dishes and cutlery being washed is transmitted to the clear rinsing water. Consequently, in the method execution according to an embodiment of the invention, this allows exclusive heat pump operation, also in the first heating phase (c1) of the clear rinsing step (c) of the program, for example, over the first ten minutes. The heat quantity needed for the further program sequence (steps (c2) and (c3)) then can no longer be generated by the heat pump 1 alone, which is why the electric heater 11 is additionally switched on during a heating phase (c2) and is operated alone during a last heating phase (c3) until the desired maximum temperature has been reached.

With the above-mentioned program sequence on the basis of an embodiment of the method execution according to the invention as shown by curve 16, in an advantageous manner, about 40% of the heating energy can be saved through the use of the heat pump, yet without lengthening the program running time.

The depiction shown in FIG. 3 relates to a low-temperature program. However, also with fast and/or intensive dishwashing programs, the combination of the two heaters, that is to say, the heat pump 1 on the one hand, and the electric heater 11 on the other hand, can achieve a higher heating output and thus a shorter heating time. For this purpose, the heater has to be additionally switched on already during the washing step of the program, and the temperature curve is similar to that of the clear rinsing in the low-temperature program (program steps (a1), (a2) and (a3)). Therefore, the use of a 2 kW electric heater 11 and of a 0.6 kW heat pump 1 can achieve a total heating output of 2.6 kW, which shortens the heating time by more than 20% in comparison to exclusively using the electric heater 11. Since the heat pump obtains 400 watts from the ambient air, additional energy savings of 15% are achieved.

While the invention has been particularly shown and described with reference to preferred embodiments thereof, it will be understood by those skilled in the art that various changes in form and details may be made therein without departing from the spirit and scope of the invention.

What is claimed is:

1. A method for carrying out a dishwashing program in an automatic dishwasher, the method comprising:
a washing step including heating water present in a tub of the dishwasher using at least a condenser of a heat pump;
an intermediate cleaning; and
a clear rinsing including heating water present in the dishwasher tub using the condenser together with an electric heater.

2. The method recited in claim 1, wherein the condenser generates at least 90% of a total heating output during the washing step.

3. The method recited in claim 2, wherein the washing step includes exclusively using the condenser for generating heating output.

4. The method recited in claim 3, wherein the washing step includes heating the water present in the dishwasher tub to above 45 ° C.

5. The method recited in claim 4, wherein the washing step includes heating the water present in the dishwasher tub to 50 ° C.

6. The method recited in claim 1, wherein the washing step includes starting a heating phase when water is fed into the dishwasher tub and operating the condenser as a heater for the heating phase.

7. The method recited in claim 1, wherein the intermediate cleaning includes at least partially replacing water in the dishwasher tub and operating the condenser as a heater.

8. The method recited in claim 1, wherein at least one of the washing step and clear rinsing includes operating only the condenser as a heater during a first heating phase, and additionally switching on the electric heater during a second heating phase.

9. The method recited in claim 8, wherein the at least one of the washing step and clear rinsing includes a third heating phase in which the electric heater is operated exclusively until a desired final temperature is reached.

10. The method recited in claim 8, wherein switching from the first heating phase to the second heating phase is carried out in a time-controlled manner.

11. The method recited in claim 9, wherein the switching from the first heating phase to the second heating phase and the second heating phase to the third heating phase is carried out in a time-controlled manner.

12. The method recited in claim 8, wherein switching from the first heating phase to the second heating phase is carried out in a temperature-controlled manner.

13. The method recited in claim 9, wherein the switching from the first heating phase to the second heating phase and the second heating phase to the third heating phase is carried out in a temperature-controlled manner.

14. The method recited in claim 1, wherein the dishwasher includes a control unit with a measuring device and a comparator circuit, the method further comprising:
detecting an actual temperature of water present in the dishwasher using the measuring device, comparing measured actual temperature to a predefinable target temperature, and
switching on the electric heater if the actual temperature is below the predefinable target temperature.
